(19) United States
(12) Patent Application Publication
(10) Pub. No.: US 2009/0092394 A1
(43) Pub. Date: Apr. 9, 2009

(54) Orthogonal Frequency Division Multiple Access Based Virtual Passive Optical Network (VPON)

(75) Inventors: Wei Wei, Plainsboro, NJ (US); Ting Wang, West Windsor, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/207,664

(22) Filed: Sep. 10, 2008

Related U.S. Application Data
(60) Provisional application No. 60/978,284, filed on Oct. 8, 2007.

(51) Int. Cl. H04J 14/02

(52) U.S. Cl. 398/79

(57) ABSTRACT

Various types of passive optical networks operate simultaneously in one passive optical network system comprising an optical line terminal, a passive remote node, and multiple optical network units. Downstream data is orthogonal frequency division multiplexed onto a single wavelength optical carrier transmitted on a primary downstream optical beam from the optical line terminal to a splitter in the passive remote node. The primary downstream optical beam is split into multiple secondary downstream optical beams; each is transmitted to a specific optical network unit. Upstream data is orthogonal frequency division multiplexed onto a single wavelength optical carrier transmitted on a secondary upstream optical beam from each optical network unit to a coupler in the passive remote node. The upstream wavelength for each optical network unit is different. The wavelength division multiplexed optical beam is transmitted from the passive remote node to a parallel signal detector in the optical line terminal.

This application claims the benefit of U.S. Provisional Application No. 60/978,284 filed Oct. 8, 2007, which is incorporated herein by reference.

### BACKGROUND OF THE INVENTION

The present invention relates generally to fiber optic transmission (transport) systems, and more particularly to orthogonal frequency division multiple access based virtual passive optical networks.

Fiber optics is a reliable technology for high-speed packet data transmission in telecommunications networks. It has been extensively deployed in core networks, in which the network equipment is typically installed in controlled environments. Environmental variables, such as temperature, humidity, vibration, and shock, are regulated according to industry standards. In addition, these installations typically have reliable power sources, including battery backup.

Multimedia services (data, voice, and video) are increasingly being provided over packet data networks. These services require high-speed communication links between customers' equipment and the core network. Furthermore, high-speed bi-directional communication links are increasingly in demand. Previously, for example, video was primarily downloaded from a server to a customer. Now, however, a customer may also desire to upload videos from his home computer to a network server or to another customer's home computer.

Communications links from a customer to an access network have primarily been provided over twisted-pair wires (to the local telephone exchange) or over coax cable (to the cable television network). Optical fiber, however, has inherently higher bandwidth than twisted-pair wires and coax cable, and, indeed, service providers are deploying fiber all the way to the customer location. Depending on the customer, service offerings are variously referred to as fiber-to-the-office, fiber-to-the-building, fiber-to-the-business, and fiber-to-the-home. Herein, the generic term fiber-to-the-premises (FTTP) is used, where premises refer to customer premises.

FTTP, however, often requires installation of equipment in outside plant, which is typically exposed to uncontrolled environments. Supplying reliable power to outside plant is also more difficult and expensive than supplying reliable power to a central office, for example. Furthermore, since communications links are geographically dispersed over many customers, management of the distribution plant is more difficult than management of the infrastructure of a central office, for example. For these reasons, passive optical networks (PONs) have been developed. The architecture and protocols of core networks have been well-defined by industry standards. For PONs, however, network architectures and network protocols are still evolving. Examples of network protocols include ATM PON (APON), Broadband PON (BPON), Ethernet PON (EPON), Gigabit PON (GPON), 10 Gigabit Ethernet PON (10GEPON), and Wavelength Division Multiplex PON (WDM-PON).

Both service providers and equipment vendors, therefore, may be faced with supporting PONs with multiple architectures and multiple protocols. Since each architecture and each protocol may require custom hardware and software, the capital expense and operating costs for initial development and for subsequent network operations, administration, maintenance, and provisioning (OAM&P) may be extremely high. In addition, new services, such as network virtualization and video streaming services (IPTV) are emerging continuously. What is needed is a cost-effective PON which may flexibly and dynamically adapt to multiple architectures, protocols, and services.

### BRIEF SUMMARY OF THE INVENTION

In an embodiment, a primary downstream optical beam carrying a downstream orthogonal frequency division multiplexed data stream is received by a passive remote node. The passive remote node splits the primary downstream optical beam into one or more secondary downstream optical beams. Each secondary optical beam is transmitted to a specific optical network unit. Each optical network unit demultiplexes its corresponding downstream data stream.

In the downstream direction, an optical line terminal (OLT) connected to a backbone network transmits the primary downstream optical beam. A single wavelength optical carrier may be used to broadcast downstream data to all optical network units (ONU). In the upstream direction, each optical network unit (ONU) sends an optical beam comprising a single wavelength carrier carrying orthogonal frequency division multiplexed data. To avoid optical beat interference, each optical network unit uses a different upstream wavelength. The upstream optical beams are sent to the remote passive node and wavelength division multiplexed. The resulting multi-wavelength upstream optical beam is transmitted to a parallel signal detector in the optical line terminal (OLT).

Each optical carrier is partitioned into a set of orthogonal frequency division multiplex subcarriers and a set of time slots. Bandwidth may be efficiently and dynamically allocated by assigning specific sets of subcarriers and time slots to different data packets.

These and other advantages of the invention will be apparent to those of ordinary skill in the art by reference to the following detailed description and the accompanying drawings.

### BRIEF DESCRIPTION OF THE DRAWINGS

FIG. 1 shows a high-level schematic of a virtual passive optical network (VPON);

FIG. 2 shows a matrix of subcarriers and time slots for bandwidth allocation;

FIG. 3 shows a high-level schematic of an optical line terminal; and

FIG. 4 shows a high-level schematic of the interface between an optical line terminal and a backbone network.

### DETAILED DESCRIPTION

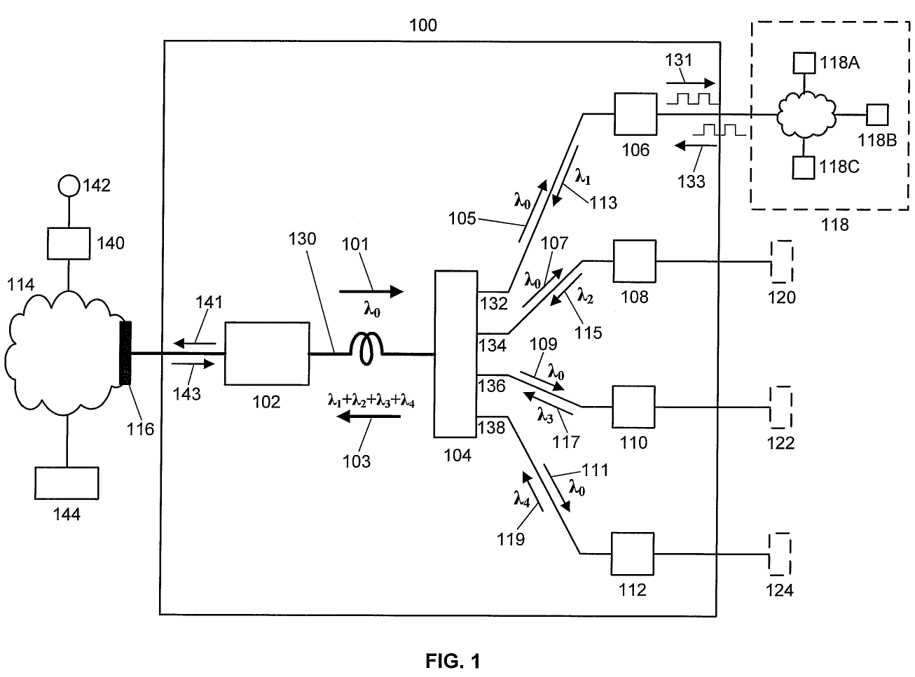

Multiple network architectures and multiple network protocols are evolving for passive optical networks (PONs). The operating environment of local access and premises networks are less defined than that of core networks. Low costs are also a more significant factor for PONs than for core networks, since the cost of a PON is amortized over fewer customers than that of a core network. FIG. 1 shows a high-level schematic of a PON, referred to as a virtual passive optical network (VPON) 100. It is referred to as a virtual passive optical network because it may flexibly and dynamically adapt to and simultaneously support multiple passive optical network protocols via software. VPON 100 may support a diverse range of users and applications without major changes in hardware.

In the embodiment shown in FIG. 1, VPON 100 includes optical line terminal OLT 102, passive remote node RN 104, and optical network units ONU1 106-ONU4 112. OLT 102 is typically located in a central office; RN 104 is typically located in outdoor plant serving multiple neighborhoods; and ONU1 106-ONU4 112 are typically located on customer premises. RN 104 is referred to as a passive remote node because it contains no components (optical or electrical) which require power. More details of RN 104 are discussed below. OLT 102 connects to backbone (core) network 114 via edge node 116, which may, for example, be a programmable router. Edge node 116 may be located in the same central office as OLT 102. Edge node 116 may also be located in a different facility and connected to OLT 102 via optical fiber, for example. In general, multiple network users may connect to backbone network 114 via remote access terminals. As an example, network administrator 142 connects to backbone network 114 via remote access terminal 140. In general, multiple servers may connect to backbone network 114. Servers may provide network operations, administration, maintenance, and provisioning (OAM&P) functions. Servers may also provide user applications. An example of a server is server 144.

Each ONU connects to a user system (US). ONU1 106-ONU4 112 connect to user system US1 118-user system US4 124, respectively. Examples of user systems include wireless systems, local area networks, and end-user equipment (such as servers, workstations, and personal computers). In FIG. 1, user system US1 118 represents a local area network with end-user equipment UE1 118A-end-user equipment UE3 118C. ONU1 106 and US1 118 communicate via communications link 131 and communications link 133. The virtual (logical) interface between an ONU and a user system may be implemented by various physical interfaces. Examples of physical interfaces include an electrical interface, a fiber optic interface, a wireless interface, and a free-space optics interface.

In an embodiment, backbone network 114 represents the GENI (Global Environment for Network Innovations) backbone network. GENI is a government, industry, and university consortium developing new network infrastructure and applications. A key GENI concept is referred to as a slice, which is a virtual partition of a network. A slice appears as an independent set of network resources under the control of a specific network user. Multiple slices supporting multiple network users may be supported in parallel. In an embodiment, VPON 100 is integrated with backbone network 114 as part of the GENI program. OLT 102 communicates with edge node 116 via communications link 141 and communications link 143. As discussed below, network administrator 142 may program edge node 116, OLT 102, and ONU1 106-ONU4 112 to provision slices of VPON 100.

Herein, traffic refers to data streams which may transport multi-media (data, voice, video) content. Herein, downstream traffic refers to data streams transmitted from backbone network 114 via edge node 116 to OLT 102, from OLT 102 to RN 104, and from RN 104 to ONU1 106-ONU4 112. Downstream traffic further refers to traffic from an ONU to a US, such as traffic from ONU1 106 to US1 118. Herein, upstream traffic refers to data streams transmitted from ONU1 106-ONU4 112 to RN 104, from RN 104 to OLT 102, and from OLT 102 via edge node 116 to backbone network 114. Upstream traffic further refers to traffic transmitted from a US to an ONU, such as traffic from US1 118 to ONU1 106.

In VPON 100, traffic is multiplexed by a combination of three multiplexing schemes: wavelength division multiplexing (WDM), orthogonal frequency division multiplexing (OFDM), and time division multiplexing (TDM). These multiplexing schemes allow bandwidth to be flexibly and adaptively shared among different users, different protocols, and different applications via a combination of wavelength division multiple access (WDMA), orthogonal frequency division multiple access (OFDMA), and time division multiple access (TDMA). These multiplexing schemes may also be used to provision slices.

WDM provides the first level (coarsest granularity) of multiplexing. In VPON 100, OLT 102 is connected to RN 104 via optical fiber OF0 130, and RN 104 is connected to ONU1 106-ONU4 112 via optical fiber OF1 132-optical fiber OF4 138, respectively. Downstream traffic from OLT 102 is transported via optical beam 101 across OF0 130 to RN 104. In an embodiment, optical beam 101 comprises four downstream optical carriers, each with a different wavelength λ₁-λ₄. Each downstream optical carrier carries downstream traffic to a specific ONU. For example, downstream λ₁ optical carrier-downstream λ₄ optical carrier carry downstream traffic to ONU1 106-ONU4 112, respectively. In the embodiment shown in FIG. 1, optical beam 101 only has a single optical carrier with wavelength λ₀. All downstream traffic from OLT 102 to ONU1 106-ONU4 112 is sent in broadcast mode. Optical beam 101 is split by an optical splitter in RN 104 into optical beam 105-optical beam 111, which carry the downstream λ₀ optical carrier to ONU1 106-ONU4 112, respectively. Downstream traffic may include the same media content (such as high definition television) sent to multiple user systems. Downstream traffic may also include media content (such as e-mail) sent to a specific user system, which decodes the appropriate data stream multiplexed (for example, by OFDMA and TDMA) in the aggregate downstream traffic.

Herein, optical beam 101 is referred to as the primary downstream optical beam, and optical beam 105-optical beam 111 are referred to as secondary downstream optical beams. Herein, an optical beam comprises one or more corresponding optical carriers, with each optical carrier having a corresponding single wavelength and carrying a corresponding data stream. Primary downstream optical beam 101 comprises one or more corresponding primary downstream optical carriers. Secondary downstream optical beam 105-secondary downstream optical beam 111 comprise one or more corresponding secondary downstream optical carriers. As discussed below, primary upstream optical beam 103 comprises one or more corresponding primary upstream optical carriers. Secondary upstream optical beam 113-secondary upstream optical beam 119 comprise one or more corresponding secondary upstream optical carriers. Herein, an optical carrier corresponding to a specific optical beam is also referred to as an optical carrier on the specific optical beam.

Upstream traffic is carried on optical carriers with different wavelengths to avoid optical beat noise interference. In the embodiment shown In FIG. 1, a single secondary upstream λ₁ optical carrier on secondary upstream optical beam 113 carries upstream traffic from ONU1 106 to RN 104. Similarly, a single secondary upstream λ₂ optical carrier on secondary upstream optical beam 115 carries upstream traffic from ONU2 108 to RN 104; a single secondary upstream λ₃ optical carrier on secondary upstream optical beam 117 carries upstream traffic from ONU3 110 to RN 104; and a single secondary upstream λ₄ optical carrier on secondary upstream optical beam 119 carries upstream traffic from ONU4 112 to RN 104. At RN 104, secondary upstream optical beam 113-secondary upstream optical beam 119 are multiplexed together to form multi-wavelength primary upstream optical beam 103, which comprises four primary upstream optical carriers with corresponding wavelengths (λ₁, λ₂, λ₃, λ₄). Primary upstream optical beam 103 is transmitted across OF0 130 to OLT 102.

The optical components of OLT 102 and ONU1 106-ONU4 112 are chosen to reduce costs. In general, an OLT and an ONU may be equipped with multiple optical transmitters, each transmitting a different wavelength, and with multiple optical receivers, each receiving a different wavelength. In the embodiment shown in FIG. 1, OLT 102 has a single optical transmitter transmitting at λ₀. ONU1 106-ONU4 112 are each equipped with a single optical transmitter transmitting at λ₁-λ₄, respectively. OLT 102 is equipped with a single parallel signal detector which simultaneously receives and processes optical carriers of different wavelengths, such as primary upstream (λ₁, λ₂, λ₃, λ₄) optical carriers on primary upstream optical beam 103. Each ONU may be equipped with an optical receiver configured to receive a corresponding single wavelength. For example, ONU1 106-ONU4 112 may each be equipped with an optical receiver configured to receive the secondary downstream λ₀ optical carrier on secondary downstream optical beam 105-secondary downstream optical beam 111, respectively. Each ONU may also be equipped with a single parallel signal detector to minimize parts inventory. That is, a common optical receiver may be used in all ONUs to accommodate different values of λ₀ in different networks.

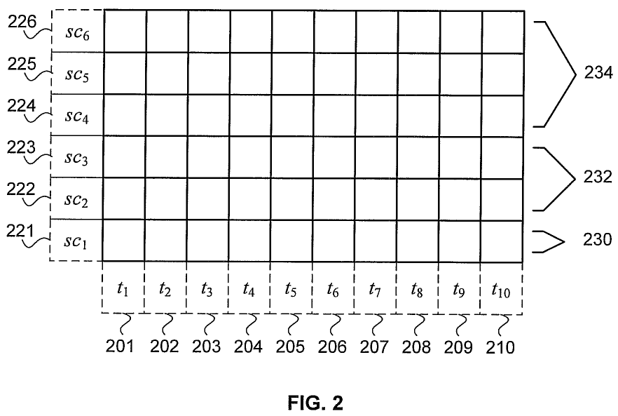

For each optical carrier, OFDM and TDM provide lower levels (finer granularity) of multiplexing. The optical bandwidth is partitioned into multiple OFDM subcarriers (sc) and time slots, as represented by the two-dimensional matrix in FIG. 2. Along the horizontal axis are plotted time slots; shown are 10 representative time slots t₁ 201-t₁₀ 210. Along the vertical axis are plotted subcarriers; shown are six representative subcarriers sc₁ 221-sc₆ 226. Herein, a group of subcarriers is referred to as a subchannel. In an embodiment, the wavelength spacing between optical carriers is specified by the ITU grid, the length of a time slot is 125 μsec, and the number of electrical subcarriers in one optical carrier is 256-2048. In an embodiment, bandwidth is allocated by a combination of subcarriers and time slots. Herein, for a specific optical carrier, a resource element refers to a matrix element (tᵢ, scⱼ), where i,j are integers ≧1. Herein, for a specific optical carrier, a resource unit refers to an arbitrary set of matrix elements. Herein, an optical carrier carries a corresponding orthogonal frequency division multiplexed data stream. The combination of WDM, OFDM, and TDM allow the network infrastructure of VPON 100 to be provisioned as a virtual network (or GENI slice) via software. That is, VPON 100 may be programmed to support multiple PON protocols, multiple ONUs, multiple user systems, and multiple types of traffic simultaneously. VPON 100 may be configured adaptively and dynamically.

Examples of various allocations of resource units are shown in FIG. 2. The bandwidth may be dynamically partitioned by allocating different number of subcarriers and different number of time slots. The subchannel comprising the single subcarrier sc₁ 221 is reserved for a control and signalling channel 230, which is discussed in more detail below. The subchannel comprising sc₂ 222 and sc₃ 223 are allocated to a slice of a G-PON (slice 232). The subchannel comprising sc₄ 224-sc₆ 226 are allocated to a slice of a customized PON (slice 234). Each slice may be further partitioned via TDM. For example, let the (tᵢ, scⱼ) matrix correspond to the downstream λ₀ optical carrier on optical beam 101 (see FIG. 1). In slice 232, time slots t₁ 201-t₂ 202 may be allocated to ONU1 106 and time slots t₃ 203-t₆ 206 may be allocated to ONU2 108. Similarly, in slice 234, time slots t₁ 201-t₄ 204 may be allocated to ONU3 110, and time slots t₅ 205-t₉ 209 may be allocated to ONU4 112.

As another example, let the (tᵢ, scⱼ) matrix in FIG. 2 correspond to the upstream λ₁ optical carrier on optical beam 113 (see FIG. 1). In slice 232, time slots may be shared among user-equipment UE1 118A-user-equipment UE3 118C in user system US1 118. For example, time slots t₁ 201-t₃ 203 may be allocated to UE1 118A, time slots t₄ 204-t₅ 205 may be allocated to UE2 118B, and time slots t₆ 206-t₁₀ 210 may be allocated to UE3 118C. Resource units may be further allocated on the basis of other user-specified criteria. For example, resource units may be allocated by type of traffic, thus guaranteeing quality of service (QoS).

The virtualization mechanisms of slice isolation and media access control (MAC) used in VPON 100 include three aspects: (a) Data isolation. Data isolation between slices is achieved by parallel optical OFDMA transmission. Each slice may include one or more ONUs with the same frame format, control protocol, and management scheme. (b) Virtual MAC. The data in each slice is first stored in different virtual queues and then forwarded to an appropriate virtual machine for processing. (c) Bandwidth resource partition. There are two levels of resource management. The first level is based on optical OFDMA between slices which controls the allocation of subcarriers for different slices. The second level may be based on TDMA (or other user-specified multiple access scheme) between ONUs within each slice to perform the functionalities of other PON protocols (for example, EPON or GPON protocols). Consequently, the subcarriers are shared through statistical multiplexing and dynamic allocation to provide efficient bandwidth utilization, as well as to improve the QoS performance of each slice or ONU.

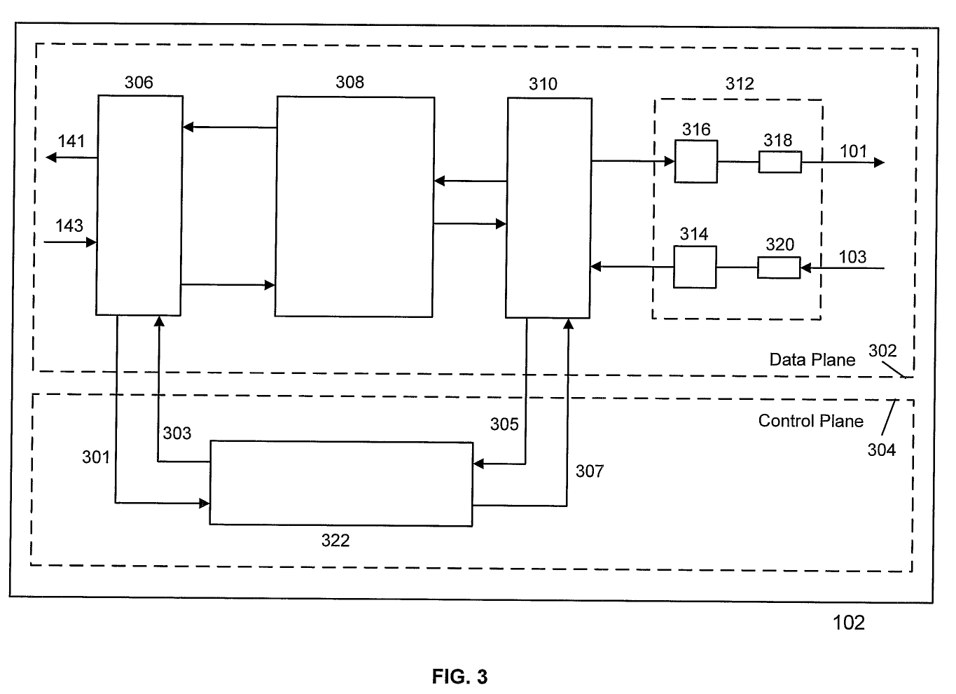

FIG. 3 shows the architecture of an embodiment of OLT 102 in FIG. 1. OLT 102 includes hardware components in the data plane 302 and software components in the control plane 304. The hardware components include a backbone interface unit 306 for slice mapping; a MAC processing unit 308 for PON MAC processing; an optical OFDMA processing unit 310 to multiplex/demultiplex and code/decode the data stream for each subcarrier; and an optical OFDMA link physical interface unit 312. Backbone interface unit 306 communicates with edge node 116 (FIG. 1) via communications link 141 and communications link 143. In an embodiment, MAC processing unit 308 is implemented by a field programmable gate array (FPGA). In an embodiment, optical OFDMA is implemented by a field programmable gate array-based digital signal processor. In an embodiment, the optical OFDMA link physical interface unit 312 includes an analog-to-digital converter ADC 314, a digital-to-analog converter DAC 316, an optical transmitter 318, and an optical receiver 320. In an embodiment, optical transmitter 318 includes a laser diode transmitting a single wavelength (λ₀) optical beam 101 (FIG. 1), which carries downstream traffic. In an embodiment, optical receiver 320 is a parallel signal detector which can simultaneously receive optical carriers with different wavelengths on multi-wavelength optical beam 103 (FIG. 1), which carries upstream traffic.

In an embodiment, control software module 322 includes GENI specific network control and management software and appropriate application programming interfaces (APIs). Data processed within OLT 102 include two types, user-specific data packets (transporting user data streams) and control packets (transporting control and signaling messages). User data streams, for example, carry multi-media content. For user-specific data packets that belong to one or more sliced networks, one or more subsets of subcarriers may be allocated according to criteria set by network administrator 142 (FIG. 1). The user-specific data packets may be framed within OLT 102 to transmit between the optical OFDMA link physical interface unit 312 and the backbone interface unit 306. Control packets that may require special operations are transported on designated subcarriers and delivered to the control software module 322. GENI control and signaling messages are sent via communication link 301 and communication link 303. VPON control and signalling messages are sent via communication link 305 and communication link 307.

In an embodiment, an optical network unit (such as ONU1 106 in FIG. 1) is similar to OLT 102. One skilled in the art may adapt the appropriate hardware and software components to permit an optical network unit to be remotely programmed and to be provisioned as a virtual network element in a slice. Differences between OLT 102 and ONU1 106 have been discussed above. As noted above, the virtual interface between an optical network unit and a user system (such as US1 118 in FIG. 1) may be implemented by various physical interfaces, including an electrical interface, a fiber optic interface, a wireless interface, and a free-space optics interface.

Referring back to FIG. 1, network administrator 142 may program and control ONU1 106-ONU4 112 via OLT 102. Network administrator 142 may access ONU1 106-ONU4 112 via a dedicated control and signaling channel (for example, control and signaling channel 230 in FIG. 2) carried by a designated subcarrier (or set of subcarriers). The control and signaling channel is transported as part of the downstream broadcast traffic carried on primary downstream optical beam 101 and secondary downstream optical beam 105-secondary downstream optical beam 111. GENI-specific control software runs in control software module 322 (FIG. 3) in OLT 102. GENI-specific control software also runs in corresponding control software modules in ONU1 106-ONU4 112. Network administrator 142 may perform various functions, including configuration and control of VPON 100, integration of VPON 100 with backbone network 114, integration of VPON 100 with user system US1 118-user system US4 124, download of specific codes (such as specific PON protocols) for execution on OLT 102 and ONU1 106-ONU4 112, and subcarrier assignments for different slices.

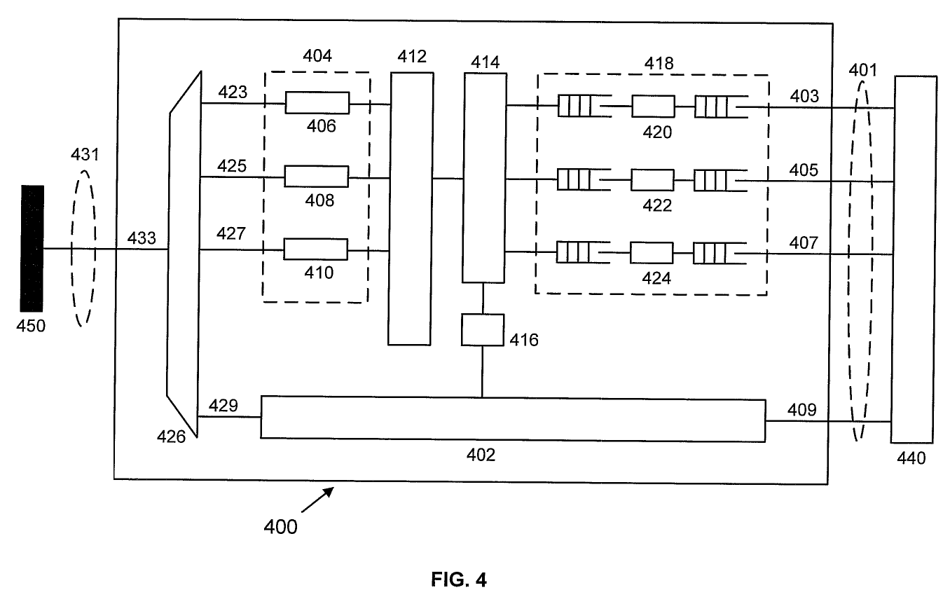

FIG. 4 shows additional details of programmable interface module 400 between optical OFDMA link physical interface unit 440 and edge node 450. The interfaces shown in the figure are virtual interfaces. Access interface 401 is the interface between programmable interface module 400 and optical OFDMA link physical interface unit 450. Backbone interface 431 is the interface between programmable interface module 400 and edge node 450. Programmable interface module 400 includes control software module 402, multiplexer/demultiplexer 426, tunnel buffer set 404, tunnel encapsulation module 412, mapping and scheduling module 414, configurable mapping table 416, and virtual buffer set 418.

Data is sent between optical OFDMA link physical interface unit 440 and edge node 450 via tunnel encapsulation. For a slice, programmable interface module 400 provides a transparent pipe from backbone interface 431 to access interface 401. Data stream DSC 409 transports control and signalling messages between control software module 402 and optical OFDMA link physical interface unit 440. Data stream DSC 429 transports control and signaling messages between control software module 402 and edge node 450.

As discussed above with respect to FIG. 2, a set of subcarriers may be assigned to a slice. In this example, on the access side of programmable interface module 400, data stream DSA1 403 is carried on a set of subcarriers assigned to an EPON; data stream DSA2 405 is carried on a set of subcarriers assigned to a GPON; and data stream DSA3 407 is carried on a set of subcarriers assigned to a custom PON (for example, a new PON protocol under development). Data streams are buffered in virtual queues. For example, data stream DSA1 403-data stream DSA3 407 are buffered in virtual queue VC 420-virtual queue VC 424, respectively.

On the backbone side of programmable interface module 400, the corresponding data streams, DSB1 423-DSB3 427, are transported via corresponding tunnels. The tunnels are buffered in tunnel buffer T1 406-tunnel buffer T3 410, respectively. Herein, a tunnel refers to a TCP/UDP/IP (Transmission Control Protocol/User Datagram Protocol/Internet Protocol) encapsulated data stream. DSB1 423-DSB3 427 are multiplexed/demultiplexed by multiplexer/demultiplexer 426 to form data stream DSM 433, which is transported across backbone interface 431 to edge node 450.

For slice provisioning, the data streams DSA1 403-DSA3 407 are mapped to data streams DSB1 423-DSB3 427, respectively. The tunnel encapsulation module 412 performs framing and un-framing of the data streams DSB1 423-DSB3 427. The mapping and scheduling module 414 is responsible for dynamically mapping data streams DSA1 403-DSA3 407 to data streams DSB1 423-DSB3 427, respectively. Mapping is performed in accordance with the entries in the configurable mapping table 416, which is controlled by control software module 402. The control software module 402 runs on a general processor (not shown) in OLT 102 (FIG. 1).

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for transmitting data across a passive optical network, comprising the steps of:
receiving at a passive remote node a primary downstream optical beam comprising at least one primary downstream optical carrier, wherein each of the at least one primary downstream optical carriers has a corresponding primary downstream wavelength and carries a corresponding primary downstream orthogonal division multiplexed data stream; and
transmitting from the passive remote node at least one secondary downstream optical beam based at least in part on the at least one primary downstream optical beam, wherein each of the at least one secondary downstream optical beams comprises at least one secondary downstream optical carrier having a corresponding secondary downstream wavelength and carrying a corresponding secondary downstream orthogonal division multiplexed data stream.

2. The method of claim 1, wherein
said step of receiving at least one primary downstream optical beam further comprises the step of:
receiving from an optical line terminal a first optical beam comprising a first optical carrier having a first wavelength and carrying a first orthogonal division multiplexed data stream; and
said step of transmitting at least one secondary downstream optical beam further comprises the steps of:
transmitting to a first optical network node a second optical beam comprising a second optical carrier having said first wavelength and carrying said first orthogonal division multiplexed data stream; and
transmitting to a second optical network node a third optical beam comprising a third optical carrier having said first wavelength and carrying said first orthogonal division multiplexed data stream.

3. The method of claim 2, further comprising the steps of:
transmitting from said first optical network node a fourth optical beam comprising a fourth optical carrier having a second wavelength and carrying a second orthogonal division multiplexed data stream; and
transmitting from said second optical network node a fifth optical beam comprising a fifth optical carrier having a third wavelength and carrying a third orthogonal division multiplexed data stream.

4. The method of claim 3, further comprising the steps of:
receiving at said passive remote node said fourth optical beam;
receiving at said passive remote node said fifth optical beam; and
wavelength division multiplexing said fourth optical beam and said fifth optical beam to form a sixth optical beam comprising a sixth optical carrier having said second wavelength and carrying said second orthogonal frequency division multiplexed data stream and a seventh optical carrier having said third wavelength and carrying said third orthogonal frequency division multiplexed data stream; and
transmitting the sixth optical beam to said optical line terminal.

5. The method of claim 4, further comprising the steps of:
receiving at said optical line terminal said sixth optical beam; and
orthogonal frequency division demultiplexing said second orthogonal frequency division multiplexed data stream and said third orthogonal frequency division multiplexed data stream.

6. The method of claim 3, further comprising the steps of:
allocating a first set of subcarriers and a first set of time slots in said second orthogonal frequency division multiplexed data stream to a first set of data packets; and
allocating a second set of subcarriers and a second set of time slots in said second orthogonal frequency division multiplexed data stream to a second set of data packets.

7. The method of claim 6, wherein said step of allocating a first set of subcarriers and a first set of time slots and said step of allocating a second set of subcarriers and a second set of time slots are controlled by a control software module.

8. The method of claim 6, wherein said first set of data packets and said second set of data packets are received from a user equipment communicating with said first optical network node.

9. The method of claim 8, wherein said first set of data packets corresponds to a first type of traffic and said second set of data packets corresponds to a second type of traffic.

10. The method of claim 6, wherein said first set of data packets is received from a first user equipment communicating with said first optical network node and said second set of data packets is received from a second user equipment communicating with said first optical network node.

11. The method of claim 1, further comprising the steps of:
receiving at an optical line terminal at least one tunnel-encapsulated data stream;
mapping the at least one tunnel-encapsulated data stream to at least one set of subcarriers and at least one set of time slots in said at least one corresponding primary downstream orthogonal frequency multiplexed data stream.

12. The method of claim 11, wherein said step of mapping is controlled by a control software module.

13. The method of claim 11, wherein said at least one set of subcarriers and said at least one set of time slots are allocated to at least one slice.

14. The method of claim 1, further comprising the steps of:
receiving at said passive remote node at least one secondary upstream optical beam comprising at least one secondary upstream optical carrier, each of the at least one secondary upstream optical carriers having a corresponding secondary upstream wavelength and carrying at least one secondary upstream orthogonal frequency division multiplexed data stream, said at least one secondary upstream orthogonal frequency division multiplexed data stream comprising at least one set of subcarriers and at least one set of time slots; and
wavelength division multiplexing the at least one secondary upstream optical beam to form a primary upstream optical beam carrying said at least one secondary upstream orthogonal frequency division multiplexed data stream.

15. The method of claim 14, further comprising the steps of:
receiving said primary upstream optical beam at an optical line terminal; and
mapping said at least one set of subcarriers and said at least one set of time slots to at least one tunnel-encapsulated data stream.

16. The method of claim 15, wherein said step of mapping is controlled by a control software module.

17. A passive optical network comprising:
an optical line terminal comprising:
a first optical transmitter configured to generate a first optical beam comprising a first optical carrier having a first wavelength; and
a first orthogonal frequency division multiplexer configured to orthogonal frequency division multiplex a first data stream onto the first optical carrier;
a remote passive node comprising:
an optical splitter configured to receive the first optical beam and split the first optical beam into a second optical beam comprising a second optical carrier having the first wavelength and carrying the first orthogonal frequency division multiplexed data stream and a third optical beam comprising a third optical carrier having the first wavelength and carrying the first orthogonal frequency division multiplexed data stream;
a first optical network unit comprising:
a first optical receiver configured to receive the second optical beam; and
a first orthogonal frequency division demultiplexer configured to orthogonal frequency division demultiplex the first orthogonal frequency division multiplexed data stream; and
a second optical network unit comprising:
a second optical receiver configured to receive the third optical beam; and
a second orthogonal frequency division demultiplexer configured to orthogonal frequency division demultiplex the first orthogonal frequency division multiplexed data stream.

18. The passive optical network of claim 17, wherein
said first optical network unit further comprises:
a second optical transmitter configured to generate a fourth optical beam comprising a fourth optical carrier having a second wavelength; and
a second orthogonal frequency division multiplexer configured to orthogonal frequency division multiplex a second data stream onto the fourth optical carrier; and
said second optical network unit further comprises:
a third optical transmitter configured to generate a fifth optical beam comprising a fifth optical carrier having a third wavelength; and
a third orthogonal frequency division multiplexer configured to orthogonal frequency division multiplex a third data stream onto the fifth optical carrier.

19. The passive optical network of claim 18, wherein said passive remote node further comprises a wavelength division multiplexer configured to:
receive said fourth optical beam;
receive said fifth optical beam; and
wavelength division multiplex said fourth optical beam and said fifth optical beam to form a sixth optical beam comprising a sixth optical carrier having said second wavelength and carrying said second orthogonal frequency division multiplexed data stream and a seventh optical carrier having said third wavelength and carrying said third orthogonal frequency division multiplexed data stream; and
transmit the sixth optical beam to said optical line terminal.

20. The passive optical network of claim 19, wherein said optical line terminal further comprises:
a third optical receiver configured to receive said sixth optical beam; and
a third orthogonal frequency division demultiplexer configured to orthogonal frequency division demultiplex said second orthogonal frequency division multiplexed data stream and said third orthogonal frequency division multiplexed data stream.

21. The passive optical network of claim 20, wherein said third optical receiver comprises a parallel signal detector.

22. The passive optical network of claim 17, wherein said optical line terminal further comprises:
a backbone interface unit;
a media access control processing unit;
an optical orthogonal frequency division multiple access processing unit; and
an optical orthogonal frequency division multiple access physical interface unit further comprising:
an analog-to-digital converter;
a digital-to-analog converter;
a single-wavelength laser diode; and
a parallel signal detector.

23. The passive optical network of claim 22, wherein said optical line terminal further comprises a programmable interface module configured to:
send control and signaling messages between said passive optical network and an edge node connected to a backbone network;
send user data streams between said passive optical network and the edge node; and
send medium access control protocols to said optical line terminal, said first optical network node, and said second optical network node.

24. The passive optical network of claim 23, wherein said optical line terminal, said first optical network unit, and said second optical network unit receives said control and signalling messages from a network administrator communicating via said backbone network.

25. The passive optical network of claim 23, wherein said programmable interface module further comprises:
a control software module;
a multiplexer;
a demultiplexer;
a tunnel buffer set;
a tunnel encapsulation module;
a mapping and scheduling module;
a configurable mapping table; and
a virtual buffer set.
